(19) United States
(12) Patent Application Publication
(10) Pub. No.: US 2025/0231446 A1
(43) Pub. Date: Jul. 17, 2025

(54) LIQUID CRYSTAL OPTICAL SHUTTER AND IMAGING DEVICE

(71) Applicant: Japan Display Inc., Tokyo (JP)

(72) Inventors: Hitoshi TANAKA, Tokyo (JP); Hirondo NAKATOGAWA, Tokyo (JP); Yoshiro AOKI, Tokyo (JP)

(21) Appl. No.: 19/097,072

(22) Filed: Apr. 1, 2025

Related U.S. Application Data
(63) Continuation of application No. PCT/JP2023/030332, filed on Aug. 23, 2023.

(30) Foreign Application Priority Data
Oct. 12, 2022 (JP) 2022-164120

(51) Int. Cl. G02F 1/1343; G02F 1/1335

(52) U.S. Cl. CPC G02F 1/13439; G02F 1/133512

(57) ABSTRACT

A liquid crystal optical shutter includes a first transparent electrode layer, a second transparent electrode layer disposed opposite the first transparent electrode layer and having a plurality of transparent segment electrodes, a liquid crystal layer disposed between the first transparent electrode layer and the second transparent electrode layer, and a light-shielding layer in which an aperture corresponding to a region including a light entry region of an optical system used for the coded imaging and wider than the light entry region, and configured to shield light in a region outside the aperture, in which the plurality of segment electrodes includes a peripheral segment electrode corresponding to a peripheral region of the light entry region including an outline of the aperture, and the mask is formed by controlling electrical signals applied to the first transparent electrode layer and each of the plurality of segment electrodes.

### CROSS REFERENCE TO RELATED APPLICATIONS

The present application is a continuation of International Application No. PCT/JP2023/030332 filed on Aug. 23, 2023 and claims priority to Japanese Patent Application No. 2022-164120 filed on Oct. 12, 2022, the disclosure of which is incorporated herein by reference.

### BACKGROUND

The present disclosure relates to a liquid crystal optical shutter and an imaging device.

In the field of coded imaging, a technique called Depth From Defocus (DFD) is known. The DFD technique is a technique that estimates a distance from the optical system of an imaging device to a subject, i.e., the deepness or depth of the subject, based on the degree of edge blur that appears in an image obtained by imaging.

The DFD technique is described, for example, in “Coded Aperture Pairs for Depth from Defocus and Defocus Deblurring” C. Zhou, S. Lin and S. K. Nayar, International Journal of Computer Vision, Vol. 93, No. 1, pp. 53, May. 2011. (Non-Patent Document 1). In the DFD technique described in Non-Patent Document 1, two masks are prepared, each having an aperture through which light passes that is positioned differently from the other. Next, for each of the two masks, coded imaging is performed in which the masks are disposed in the light entry region of the optical system and the same subject is imaged. Next, the two imaged images obtained by the coded imaging are subjected to decoding processing based on a point spread function specific to each mask, and the depth of the subject is estimated. The point spread function is generally referred to as PSF, and is also referred to as blur function, blur spread function, a point image distribution function, etc.

### SUMMARY

The DFD technique is still in the process of development and has significant room for improvement in terms of practicality. Due to the above circumstances, a more practical DFD technique is desired.

Among the disclosures disclosed in the present application, a representative disclosure will be outlined as follows.

One representative embodiment of the present disclosure is a liquid crystal optical shutter that includes a first transparent electrode layer, a second transparent electrode layer disposed opposite the first transparent electrode layer and having a plurality of transparent segment electrodes, a liquid crystal layer disposed between the first transparent electrode layer and the second transparent electrode layer, and a light-shielding layer in which an aperture corresponding to a region including a light entry region of an optical system used for the coded imaging and wider than the light entry region, and configured to shield light in a region outside the aperture, in which the plurality of segment electrodes includes a peripheral segment electrode corresponding to a peripheral region of the light entry region including an outline of the aperture, and the mask is formed by controlling electrical signals applied to the first transparent electrode layer and each of the plurality of segment electrodes.

A representative embodiment of the present disclosure is an imaging device including the liquid crystal optical shutter.

### BRIEF DESCRIPTION OF THE DRAWINGS

FIG. 1 is a schematic diagram illustrating a configuration example of a liquid crystal optical shutter according to a first embodiment.

FIG. 2 is an exploded view illustrating the liquid crystal optical shutter according to the first embodiment.

FIG. 3 is a diagram illustrating a configuration of a light-shielding layer and a second transparent electrode layer.

FIG. 4 is a diagram for explaining formation of masks using a liquid crystal optical shutter without misalignment of the light-shielding layer.

FIG. 5 is a diagram for explaining formation of masks using the liquid crystal optical shutter with misalignment of the light-shielding layer.

FIG. 6 is a diagram illustrating a configuration example of an imaging device according to a second embodiment.

FIG. 7 is a diagram illustrating an example of a configuration of an arithmetic control unit according to the second embodiment.

FIG. 8 is a flowchart illustrating an example of an operation flow of the imaging device according to the second embodiment.

FIG. 9 is a diagram illustrating an example of two masks used in the DFD technique.

FIG. 10 is a schematic diagram illustrating a configuration example of a general liquid crystal optical shutter.

FIG. 11 is an exploded view illustrating the general liquid crystal optical shutter.

FIG. 12 is a diagram illustrating a configuration of a light-shielding layer and a second transparent electrode layer.

FIG. 13 is a diagram for explaining formation of masks using the liquid crystal optical shutter.

FIG. 14 is a diagram illustrating how an aperture pattern of a mask changes due to misalignment of the light-shielding layer.

FIG. 15 is a flow chart illustrating an example of a manufacturing method of a liquid crystal optical shutter.

### DETAILED DESCRIPTION

Before description of each embodiment of the present disclosure, the DFD technique related to the present disclosure will be described.

The state of blur of a subject in an imaged image generally depends on a point spread function, which is determined by an optical system of an imaging device, the shape of a light entry region of the optical system, and the like. When a mask that partially shields light is disposed in the light entry region of the optical system, the point spread function is determined for each mask. Imaging a subject with an imaging device in which a mask is disposed is referred to as coded imaging. When the object is imaged using coded imaging, a blurred image is obtained based on a point spread function specific to the mask used.

When the blurred image is subjected to decoding processing that involves deconvolution based on the point spread function specific to the mask used, a decoded image with reduced blur and depth information of the object corresponding to each position in the decoded image are obtained.

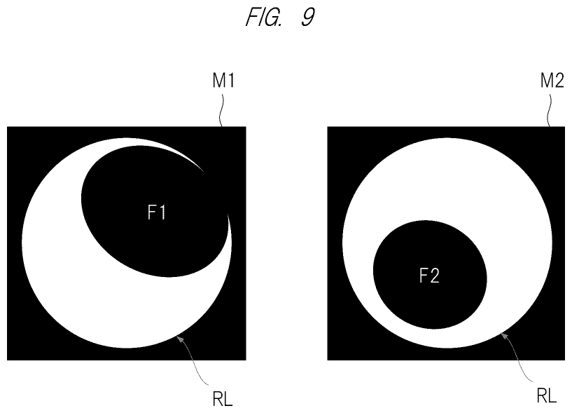

FIG. 9 is a diagram illustrating an example of two masks used in the DFD technique. In Non-Patent Document 1, the DFD technique based on coded imaging using two masks is described. In the two masks M1 and M2 illustrated in FIG. 9, the black regions are regions that shield the light entering the optical system, and the white regions are aperture regions that pass the light entering the optical system. The two masks M1 and M2 as illustrated in FIG. 9 have different geometric patterns of apertures through which the light can pass (hereinafter, also referred to as aperture patterns).

The mask M1 is a mask in which a light-shielding region F1 being elliptical is formed at the upper right of a light entry region RL being circular. The mask M2 is a mask in which a light-shielding region F2 being elliptical is formed at the lower left of the light entry region RL.

In the present specification, the light entry region RL may be the entire region where the light enters the optical system of the imaging device from the subject, or may be a region narrower than the above region. The light entry region RL is generally defined by a user in relation to the optical system, but it may also be determined based on other factors. Further, the light entry region RL is generally a circular region, but is not limited thereto.

In the DFD technique using coded imaging using a plurality of masks with different aperture patterns, one conceivable method for switching between the plurality of masks is to install a liquid crystal optical shutter in the light entry region, which is the region where the light enters the optical system.

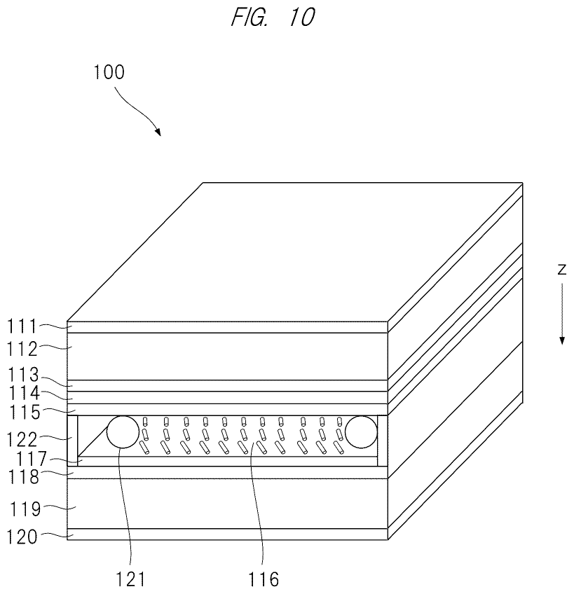

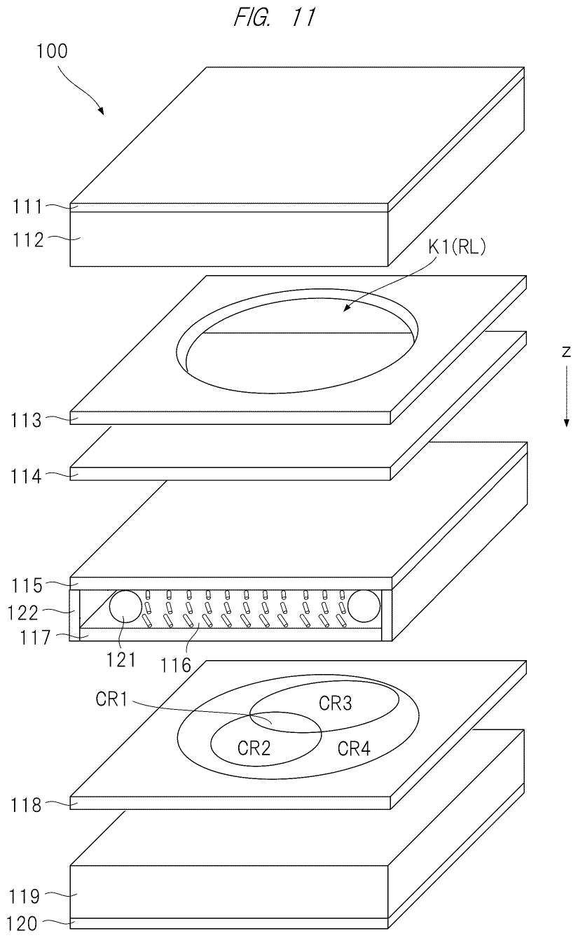

FIG. 10 is a schematic diagram illustrating a configuration example of a general liquid crystal optical shutter. Also, FIG. 11 is an exploded view illustrating the general liquid crystal optical shutter 100. A z direction in the drawings is the main axis direction of the optical system of the imaging device.

As illustrated in FIGS. 10 and 11, the liquid crystal optical shutter 100 includes a first polarizing plate 111, a first glass substrate 112, a light-shielding layer 113, a first transparent electrode layer 114, a first alignment film 115, a liquid crystal layer 116, a second alignment film 117, a second transparent electrode layer 118, a second glass substrate 119, a second polarizing plate 120, a spacer 121, and a sealing layer 122.

Here, it is assumed that the liquid crystal optical shutter 100 forms the masks M1, M2 illustrated in FIG. 9. In order to be able to form these masks M1, M2, an aperture K1 of the same shape and size as the light entry region RL of the optical system is formed in the light-shielding layer 113, and four segment electrodes CR1 to CR4 corresponding to divided regions obtained by dividing the light entry region RL are formed in the second transparent electrode layer 118.

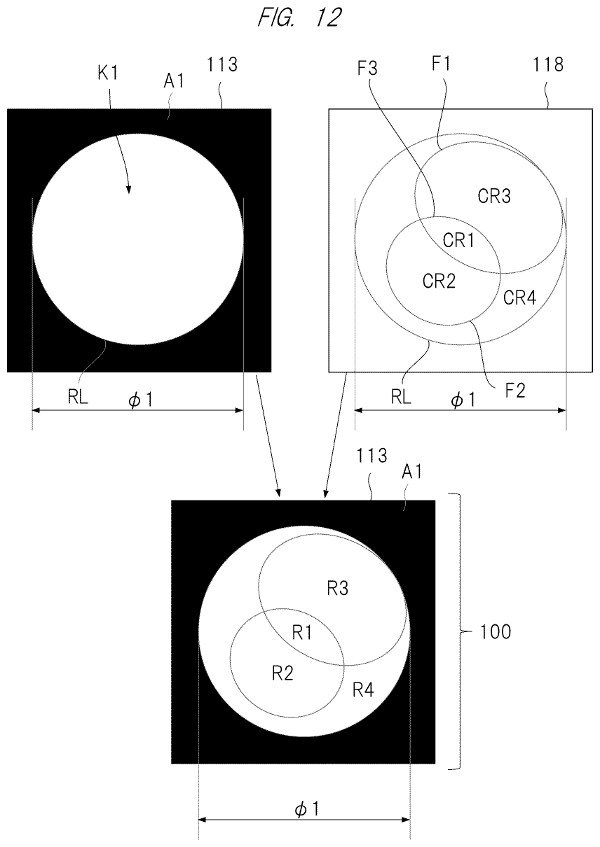

FIG. 12 is a diagram illustrating a configuration of the light-shielding layer 113 and the second transparent electrode layer 118. As illustrated in FIG. 12, the light-shielding layer 113 shields light in a region A1 other than the aperture K1. The region of the aperture K1 is, for example, a circular region having a diameter σ1. The light-shielding layer 113 is made of, for example, a metal or a resin, and has a black color that absorbs light.

As illustrated in FIG. 12, the segment electrodes CR1 to CR4 of the second transparent electrode layer 118 correspond to the segments R1 to R4 formed in the liquid crystal optical shutter 100, respectively. The segments are regions in the liquid crystal layer 116 that can independently take either a light-shielding state or a light-transmitting state by controlling an electrical signal applied to each of the segment electrodes CR1 to CR4 in the first transparent electrode layer 114 and the second transparent electrode layer 118.

The segment R1 is a segment corresponding to an overlapping region F3 where the light-shielding region F1 in the upper right of the mask M1 and the light-shielding region F2 in the lower left of the mask M2 overlap each other. The segment R2 is a segment corresponding to a region where the overlapping region F3 is removed from the light-shielding region F2. The segment R3 is a segment corresponding to a region where the overlapping region F3 is removed from the light-shielding region F1. The segment R4 is a segment corresponding to a region where the light-shielding regions F1, F2, that is, the segments R1 to R3, are removed from the light entry region RL.

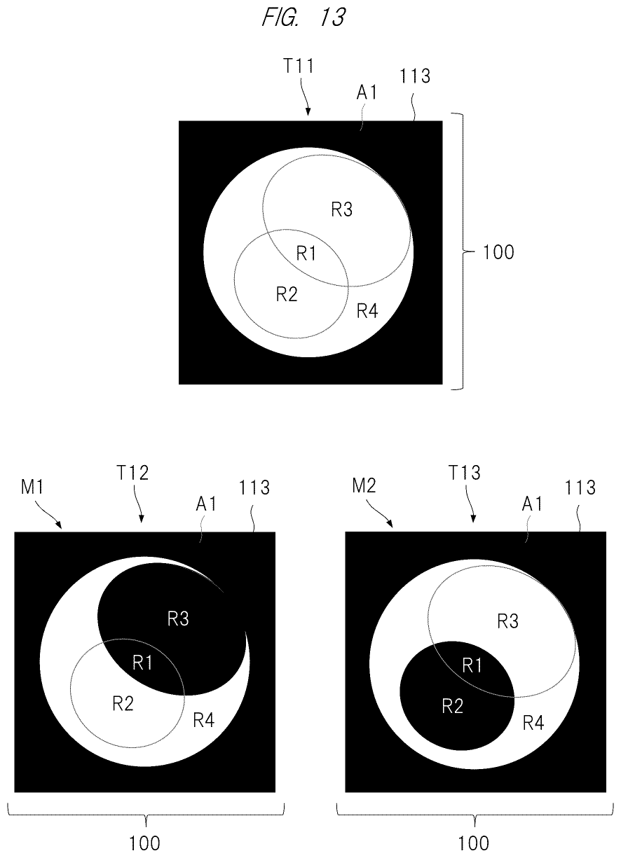

FIG. 13 is a diagram for explaining formation of the masks M1, M2 using the liquid crystal optical shutter 100. When the masks are not formed, processing is performed in which necessary electrical signals are applied to the first transparent electrode layer 114 and each segment electrode so that the segments R1 to R4 are in the light-transmitting state, as illustrated in State T11 of FIG. 13.

When the mask M1 is formed, processing is performed in which necessary electrical signals are applied to the first transparent electrode layer 114 and each segment electrode so that the segments R1 and R3 are in the light-shielding state and the segments R2 and R4 are in the light-transmitting state, as illustrated in State T12 of FIG. 13. When the mask M2 is formed, processing is performed in which necessary electrical signals are applied to the first transparent electrode layer 114 and each segment electrode so that the segments R1 and R2 are in the light-shielding state and the segments R3 and R4 are in the light-transmitting state, as illustrated in State T13 of FIG. 13.

Meanwhile, the present inventors have found that when the liquid crystal optical shutter is used to form the masks as described above, the following problem occurs.

In a liquid crystal optical shutter, due to the characteristics of current manufacturing technique, the accuracy of the positions and shape of the segment electrodes can be made relatively high, but the accuracy of the position of the light-shielding layer tends to be relatively low. That is, the accuracy of alignment between the light-shielding layer and each segment electrode tends to be low. If the accuracy of alignment between the light-shielding layer and each segment electrode is low, misalignment between an actually formed mask aperture pattern and an intended aperture pattern cannot be negligible. Therefore, when an imaged image obtained by coded imaging is decoded, the estimated accuracy of depth of the subject lowers. How the aperture pattern of the mask becomes misaligned from the originally intended aperture pattern will be described with reference to the drawing.

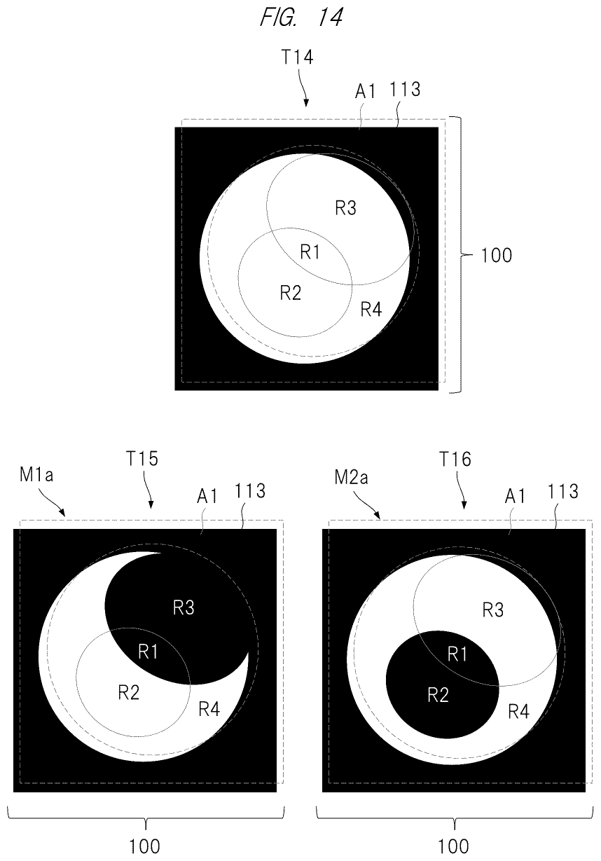

FIG. 14 is a diagram illustrating how the aperture pattern of the mask changes due to misalignment of the light-shielding layer.

As illustrated in State T14 in FIG. 14, if the light-shielding layer 113 is misaligned from the originally intended position indicated by dashed lines, for example, the light-shielding layer 113 may encroach on part of the segment, or a region outside the segment where light is always transmitted may be formed.

Therefore, for example, even when attempting to form the mask M1 as illustrated in State T15 of FIG. 14 by setting the segments R1 and R3 to the light-shielding state and the segments R2 and R4 to the light-transmitting state, a mask M1a different from the mask M1 is formed. Similarly, for example, even when attempting to form the mask M2 as illustrated in State T16 of FIG. 14 by setting the segments R1 and R2 to the light-shielding state and the segments R3 and R4 to the light-transmitting state, a mask M2a different from the mask M2 is formed.

The cause of the above problem can be more easily understood by understanding the general manufacturing method of a liquid crystal optical shutters, i.e., a liquid crystal panel. Therefore, an example of a method that is generally considered as a method of manufacturing a liquid crystal optical shutter will be described below.

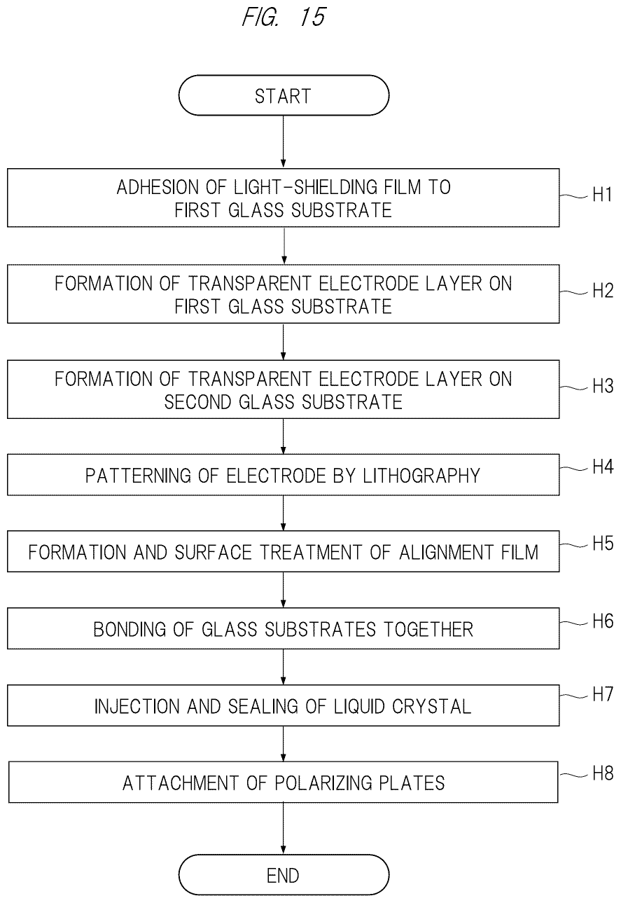

FIG. 15 is a flow chart illustrating an example of a manufacturing method of a liquid crystal optical shutter. It is assumed that the main manufacturing steps of the liquid crystal optical shutter will be performed by the user operating a dedicated robot or device, and some of the manufacturing steps may be performed by the user themselves.

As illustrated in FIG. 15, first, in Step H1, the light-shielding layer 113 is bonded to the first glass substrate 112. Specifically, a process step is performed in which the light-shielding layer 113 is bonded to the first glass substrate 112 with an adhesive or the like.

Next, in Step H2, a transparent electrode layer is formed on the first glass substrate 112. Specifically, a process step is performed in which a transparent conductive film is deposited onto the first glass substrate 112 to which the light-shielding layer 113 is adhered to form a first transparent electrode layer 114 that serves as a common electrode.

Next, in Step H3, a transparent electrode layer is formed on the second glass substrate 119. Specifically, a process step is performed in which a transparent conductive film is deposited onto the second glass substrate 119.

Next, in Step H4, an electrode pattern is processed by photolithography. Specifically, a process step is performed in which a pattern of a plurality of segment electrodes is drawn on the transparent conductive film deposited on the second glass substrate 119 by photolithography. It is noted that the processing precision of electrode patterns by lithography is known to be extremely high, and it is said that processing can be performed within an error margin of approximately 1 μm.

Next, in Step H5, an alignment film is formed and is subjected to a surface treatment. Specifically, a process step of forming a first alignment film 115 under the first transparent electrode layer 114, and forming a second alignment film 117 above the second transparent electrode layer 118 is performed. Also, a process step is performed in which fine grooves for aligning liquid crystal molecules in a certain direction are formed on the surfaces of the first alignment film 115 and the second alignment film 117.

Next, in Step H6, the glass substrates are bonded together. Specifically, a work process is performed in which spacers 121 are interposed between the first glass substrate 112 and the second glass substrate 119, and the peripheral portion of the first glass substrate 112 and the peripheral portion of the second glass substrate 119 are fixed together with a sealing layer 122. The glass substrates can be bonded together with an error margin of approximately 1 μm to 5 μm.

Next, in Step H7, liquid crystal is injected and sealed. Specifically, a process step is performed in which liquid crystal is injected between the first glass substrate 112 and the second glass substrate 119 and the injection port is then sealed to form the liquid crystal layer 116.

Next, in H8, polarizing Step plates are attached. Specifically, a process step is performed in which a first polarizing plate 111 is attached to the outer side of the first glass substrate 112, that is, the surface opposite to the liquid crystal layer 116. Also, a process step is performed in which a second polarizing plate 120 is attached to the outer side of the second glass substrate 119, that is, the surface opposite to the liquid crystal layer 116.

As described above, the second transparent electrode layer 118 is formed by depositing a transparent conductive film on the second glass substrate 119 and a pattern of the electrode is processed by lithography. Each segment is formed to correspond to the position and the shape of each segment electrode in the second transparent electrode layer 118; therefore, misalignment from the intended position on the glass substrate can be suppressed to approximately 1 μm to 2 μm.

Meanwhile, the light-shielding layer 113 is adhered to the first glass substrate 112 using an adhesive or the like. In this case, the light-shielding layer 113 may be misaligned from the intended position on the first glass substrate 112 by a relatively large amount, as much as approximately 5 μm to 10 μm. When the position of the light-shielding layer 113 is misaligned from the position of the first glass substrate 112, the position of the light-shielding layer 113 is also misaligned from the position of the second transparent electrode layer 118 formed on the second glass substrate 119.

If the light-shielding layer 113 is significantly misaligned, it may encroach on a part of the light entry region RL, and the aperture pattern of the mask to be actually formed may misaligned from the intended aperture pattern to a non-negligible extent. As a result, if coded imaging is performed using the mask in which the aperture pattern that is misaligned from the intended position, and the resulting imaged image is decoded based on a point spread function corresponding to the intended aperture pattern, accuracy of the depth of the subject is to be reduced.

Due to the above circumstances, a technique is desired that the misalignment between the aperture pattern of the mask to be formed and the intended aperture pattern can be reduced in the liquid crystal optical shutter configured to form a mask for coded imaging.

In view of the above circumstances, the present inventors conducted extensive research and devised the present disclosure. Each embodiment of the present disclosure will be described below. It should be noted that each embodiment described below is an example for implementing the present disclosure, and does not limit the technical scope of the present disclosure. Further, in each embodiment below, components having the same functions are denoted by the same reference numerals, and repeated explanations thereof will be omitted unless particularly necessary.

### First Embodiment

A liquid crystal optical shutter according to a first embodiment of the present application will be described. A liquid crystal optical shutter according to the first embodiment of the present application is a liquid crystal optical shutter configured to form a mask used in coded imaging includes a first transparent electrode layer, a second transparent electrode layer disposed opposite the first transparent electrode layer and having a plurality of transparent segment electrodes, a liquid crystal layer disposed between the first transparent electrode layer and the second transparent electrode layer, and a light-shielding layer in which an aperture corresponding to a region including a light entry region of an optical system used for coded imaging and wider than the light entry region, and configured to shield light in a region outside the aperture, in which the plurality of segment electrodes includes a peripheral segment electrode corresponding to a peripheral region of the light entry region including an outline of the aperture, in which the mask is formed by controlling electrical signals applied to the first transparent electrode layer and each of the plurality of segment electrodes. The details of the liquid crystal optical shutter are as follows.

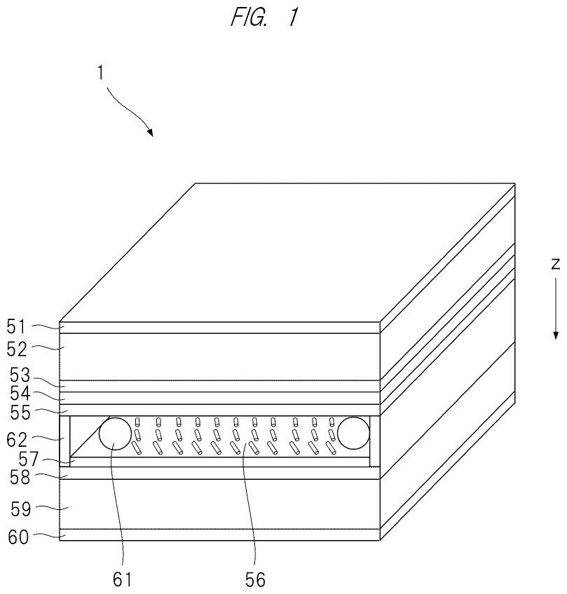

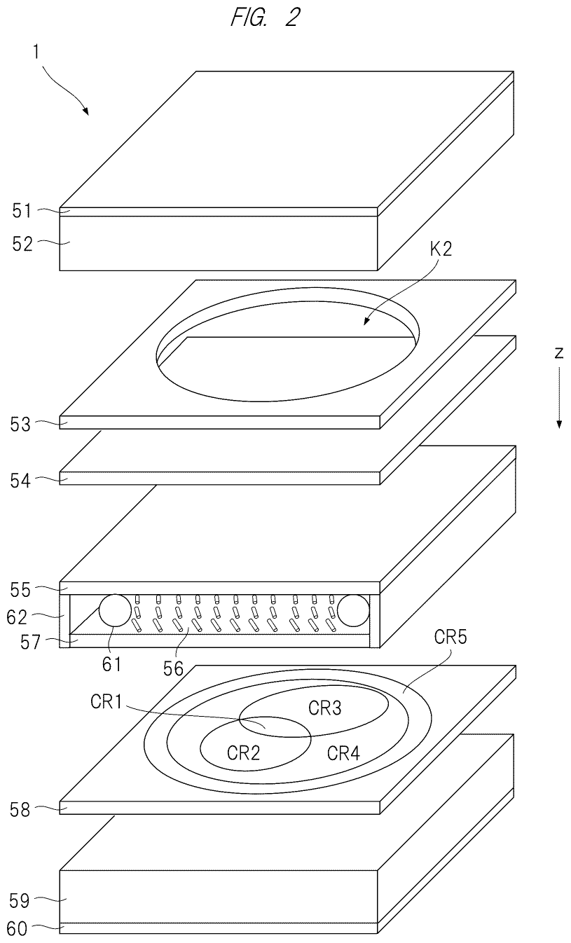

FIG. 1 is a schematic diagram illustrating a configuration example of the liquid crystal optical shutter according to the first embodiment. FIG. 2 is an exploded view illustrating the liquid crystal optical shutter according to the first embodiment. A z direction in the drawing is a main axis direction of the optical system of an imaging device.

As illustrated in FIGS. 1 and 2, a liquid crystal optical shutter 1 includes a first polarizing plate 51, a first glass substrate 52, a light-shielding layer 53, a first transparent electrode layer 54, a first alignment film 55, a liquid crystal layer 56, a second alignment film 57, a second transparent electrode layer 58, a second glass substrate 59, a second polarizing plate 60, a spacer 61, and a sealing layer 62.

Here, the liquid crystal optical shutter 1 forms masks M1, M2 illustrated in FIG. 9. In order to form the masks M1, M2, the light-shielding layer 53 is formed with an aperture K2 corresponding to a region including the light entry region RL of the optical system and wider than the light entry region RL. In the first embodiment, the aperture K2 has a shape similar to that of the light entry region RL, and has a size that extends outward by a width V beyond the light entrance region RL. The second transparent electrode layer 58 is provided with a total of five electrodes: four segment electrodes CR1 to CR4 and peripheral segment electrode CR5.

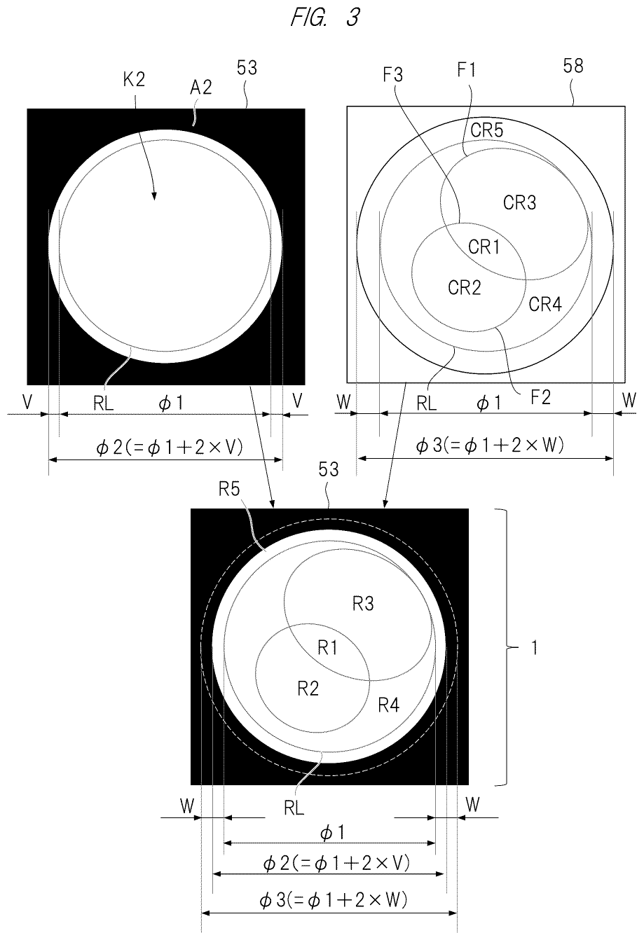

FIG. 3 is a diagram illustrating a configuration of a light-shielding layer 53 and a second transparent electrode layer 58. As illustrated in FIG. 3, the light-shielding layer 53 shields light in an outside region A2 of the aperture K2. In the first embodiment, the light entry region RL is a circular region having a diameter σ1, and the region of the aperture K2 is, for example, a circular region having a diameter σ2 (=σ1+2×V). The light-shielding layer 53 is made of, for example, a metal or a resin, and has a black color that absorbs light.

As illustrated in FIG. 3, the segment electrodes CR1 to CR4 and the peripheral segment electrode CR5 in the second transparent electrode layer 58 correspond to segments R1 to R4 and a peripheral segment R5 formed in the liquid crystal optical shutter 1, respectively.

The segments R1 to R4 are similar to the segments R1 to R4 in the liquid crystal optical shutter 100 described above. That is, the segment R1 is a segment corresponding to an overlapping region F3 where the light-shielding region F1 in the upper right of the mask M1 and the light-shielding region F2 in the lower left of the mask M2 overlap each other. The segment R2 is a segment corresponding to a region where the overlapping region F3 is removed from the light-shielding region F2. The segment R3 is a segment corresponding to a region where the overlapping region F3 is removed from the light-shielding region F1. The segment R4 is a segment corresponding to a region where the light-shielding regions F1, F2, that is, the segments R1 to R3 are removed from the light entry region RL.

The peripheral segment R5 is a segment corresponding to the combined region of the segments R1 to R4, that is, the peripheral region of the light entrance region RL. In the first embodiment, the peripheral segment R5 is a ring-shaped segment disposed adjacent to the outside of the light entry region RL. The width of the band of the peripheral segment R5 is W. That is, the diameter of the circle forming the inner end portion of the peripheral segment R5 is σ1, and the diameter of the circle forming the outer end portion of the peripheral segment R5 is σ3 (=σ1+2×W).

The width V and the width W are designed so that the light-shielding layer 53 will not extend beyond the inner edge portion of the peripheral segment R5, even if the light-shielding layer 53 is misaligned from its intended position by the maximum anticipated amount of misalignment. The width W of the band of the peripheral segment R5 is designed to be, for example, several times to ten and several times the maximum anticipated amount of misalignment of the light-shielding layer 53. If the maximum anticipated amount of misalignment is, for example, 5 μm, the width W is, for example, 10 μm to 30 μm, and the width V is, for example, W/2. The target position for disposing the light-shielding layer 53 is, for example, a position where the inner end portion of the light-shielding layer 53 is as close as possible to the center of the band of the peripheral segment R5.

The specific values of the width V and the width W are merely examples and are not limited thereto. However, the specific values in the first embodiment are merely examples of realistic values in consideration of current t manufacturing techniques, the estimated amount of misalignment of the light-shielding layer, and the like, when manufacturing a liquid crystal optical shutter.

Here, the formation of masks by the liquid crystal optical shutter 1 will be described. First, the case where the light-shielding layer 53 is disposed at the intended position will be considered.

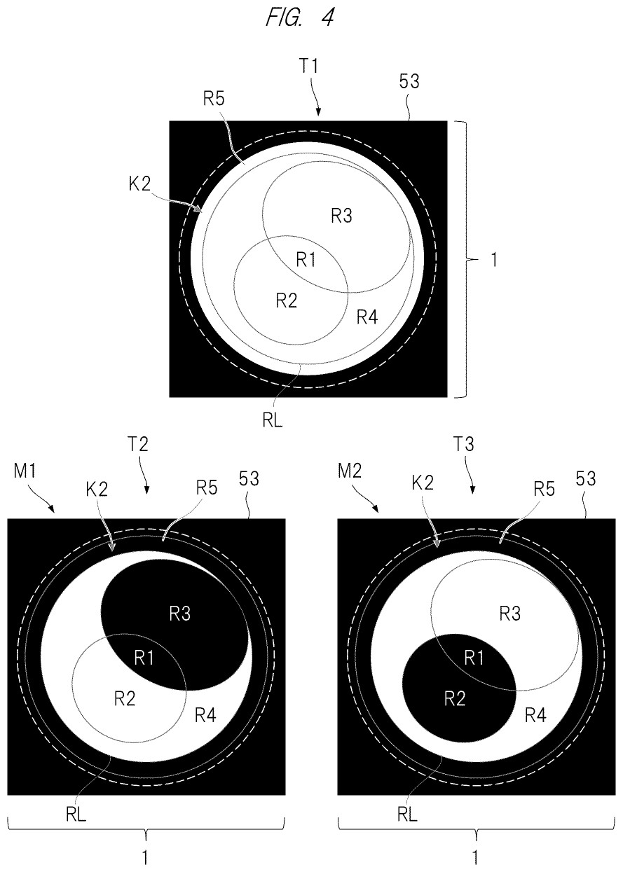

FIG. 4 is a diagram for explaining formation of masks using the liquid crystal optical shutter 1 without misalignment of the light-shielding layer.

When the masks are not formed, processing is performed in which necessary electrical signals are applied to the first transparent electrode layer 54 and an electrode corresponding to each segment electrode so that the segments R1 to R4 are in the light-transmitting state and the peripheral segment R5 is in the light-shielding state.

When the mask M1 is formed, processing is performed in which necessary electrical signals are applied to the first transparent electrode layer 54 and an electrode corresponding to each segment electrode so that the segments R1, R3, and R5 are in the light-shielding state and the segments R2 and R4 are in the light-transmitting state, as illustrated in State T2 of FIG. 4.

Further, when the mask M2 is formed, processing is performed in which necessary electrical signals are applied to the first transparent electrode layer 54 and an electrode corresponding to each segment electrode so that the segments R1, R2, and R5 are in the light-shielding state and the segments R3 and R4 are in the light-transmitting state, as illustrated in State T3 of FIG. 4.

Next, the case where the light-shielding layer 53 is disposed at a position misaligned from the intended position will be considered.

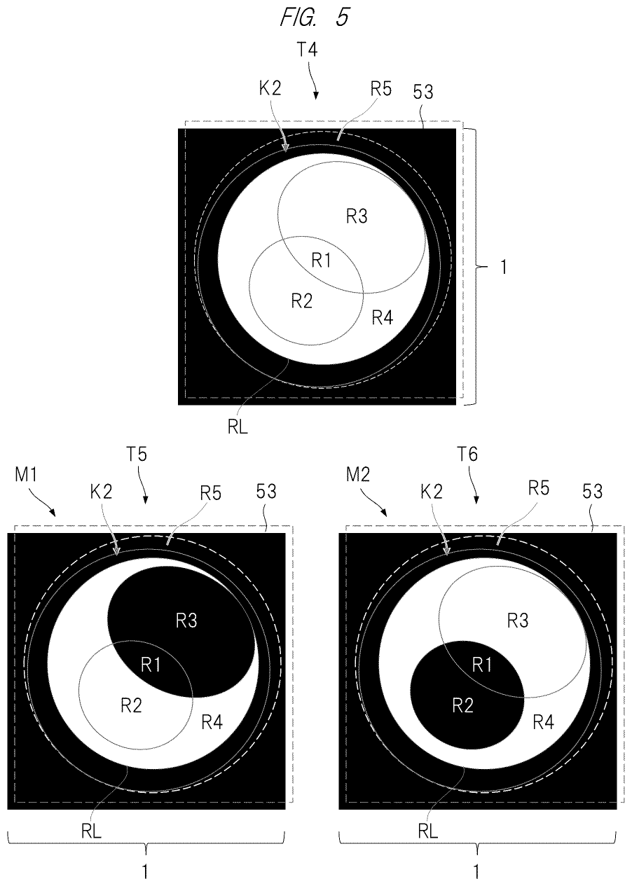

FIG. 5 is a diagram for explaining formation of masks using the liquid crystal optical shutter 1 with misalignment of the light-shielding layer.

When the masks are not formed, similar to the case where there is no misalignment of the light-shielding layer 53, the electrical signal applied to each electrode is controlled so that the segments R1 to R4 are in the light-transmitting state, and the peripheral segment R5 is in the light-shielding state, as illustrated in State T4 of FIG. 5. Although the light-shielding layer 53 is positioned at a position misaligned from the intended position illustrated by the dashed line, the end portion of the aperture K2 of the light-shielding layer 53 remains hidden in the peripheral segment R5, which is in the light-shielding state, and does not encroach on the light entry region RL, that is the region of the segments R1 to R4. Therefore, a state in which an aperture is formed as intended, and no mask is formed can be obtained.

When the mask M1 is formed, similar to the case where there is no misalignment of the light-shielding layer 53, the electrical signal applied to each electrode is controlled so that the segments R1, R3, and the peripheral segment R5 are in the light-shielding state, and the segments R2 and R4 are in the light-transmitting state, as illustrated in State T5 of FIG. 5. In this case too, although the light-shielding layer 53 is positioned at a position misaligned from the intended position, the end portion of the aperture K2 of the light-shielding layer 53 remains hidden in the peripheral segment R5 and does not encroach on the light entry region RL, that is the region of the segments R1 to R4. Therefore, it is possible to form the mask M1 with the aperture formed as intended.

Also, when the mask M2 is formed, similar to the case where there is no misalignment of the light-shielding layer 53, the electrical signal applied to each electrode is controlled so that the segments R1, R2, and the peripheral segment R5 are in the light-shielding state, and the segments R3 and R4 are in the light-transmitting state, as illustrated in State T6 of FIG. 5. In this case too, although the light-shielding layer 53 is positioned at a position misaligned from the intended position, the end portion of the aperture K2 of the light-shielding layer 53 remains hidden in the peripheral segment R5 and does not encroach on the light entry region RL, that is the region of the segments R1 to R4. Therefore, it is possible to form the mask M2 with the aperture formed as intended.

As described above, the second transparent electrode layer 58 is formed by depositing a transparent conductive film on the second glass substrate 59. Each segment is formed to correspond to the shape of each electrode in the second transparent electrode layer 58; therefore, misalignment from the intended position on the glass substrate can be suppressed to approximately 1 μm to 2 μm.

Meanwhile, the light-shielding layer 53 is adhered to the first glass substrate 52. When the light-shielding layer 53 is bonded, it is difficult to maintain high positional accuracy with respect to the glass substrate, and there is a possibility that the light-shielding layer 53 and the segments R1 to R4 may be misaligned by several μm to 10 μm from the intended alignment positions.

However, in the first embodiment, the plurality of segments includes, in addition to the segments R1 to R4 corresponding to the light entry region RL, the ring-shaped peripheral segment R5 arranged outside the light entry region RL. That is, in the second transparent electrode layer 58, a ring-shaped peripheral segment electrode CR5 corresponding to the ring-shaped peripheral segment R5 is provided. If the peripheral segment R5 is placed in the light-shielding state when the mask is formed, then even if the light-shielding layer 53 is misaligned from the intended position, the inner end portion of the peripheral segment R5 can be ensured with high positional accuracy.

Therefore, even if a relatively large misalignment occurs in the light-shielding layer 53, the aperture pattern of the mask to be formed is not affected by the misalignment, and the difference from the intended aperture pattern can be reduced.

According to the first embodiment, a more practical DFD technique can be provided. More specifically, with the liquid crystal optical shutter 1, due to the above-mentioned configuration, even if the light-shielding layer 53 is misaligned from the intended position, the misalignment is absorbed by the presence of the peripheral segment R5. That is, the aperture pattern of the mask to be formed does not change. When the aperture of the mask pattern does not change, misalignment of the light-shielding layer 53 does not affect decoding, even if the imaged image obtained by coded imaging is decoded based on a point spread function corresponding to the originally intended mask aperture pattern. Therefore, when an imaged image obtained by coded imaging is decoded, the estimated accuracy of depth of the subject based on the misalignment of the light-shielding layer 53 becoming lower can be eliminated. The effect will lead to improved practicality in DFD technique.

### Modification

The liquid crystal optical shutter 1 may have a configuration in which, of the plurality of segment electrodes, two or more segment electrodes corresponding to segments that are commonly in the light-shielding state when a plurality of masks is formed include a peripheral segment electrode CR5 and are connected to each other.

When imaging the subject, the ring-shaped peripheral segment R5 is constantly in the light-shielding state. Therefore, the liquid crystal optical shutter 1 has a configuration in which an electrode corresponding to the ring-shaped peripheral segment R5 is connected to an electrode corresponding to a segment that is constantly in the light-shielding state during the formation of the mask. For example, in the first embodiment, the liquid crystal optical shutter 1 has a configuration in which the peripheral segment electrode CR5 corresponding to the peripheral segment R5 and the segment electrode CRI corresponding to the segment R1 are connected to each other.

With this configuration, the electrodes of the plurality of segments that are in the light-shielding state can be combined into a single electrode, which not only simplifies the wiring of the electrodes but also reduces the wiring area that contributes to decreased transparency.

### Second Embodiment

An imaging device according to a second embodiment will be described. The imaging device according to the second embodiment is an imaging device that includes the liquid crystal optical shutter according to the first embodiment.

### Configuration Example of Imaging Device

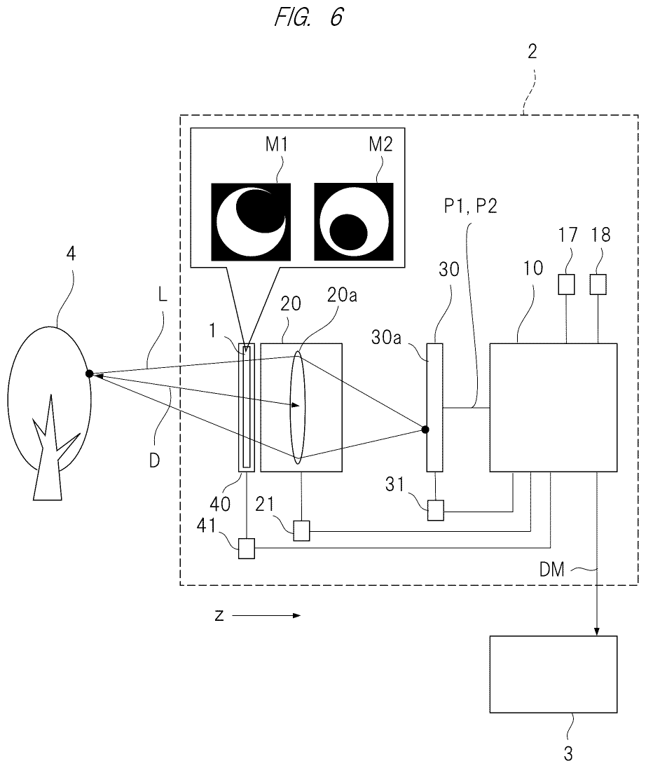

FIG. 6 is a diagram illustrating a configuration example of the imaging device according to the second embodiment. As illustrated in FIG. 6, an imaging device 2 of the second embodiment includes an optical system unit 20, an imaging element 30, a liquid crystal mask unit 40, an optical system control unit 21, an imaging element control unit 31, a liquid crystal mask control unit 41, and an arithmetic control unit 10. A z direction in the drawing is a main axis direction of the optical system unit 20.

The optical system unit 20 collects light L, which is emitted or reflected light from a subject 4, and forms an image on a light receiving surface 30a of the imaging element 30, which will be described later. The optical system unit 20 includes a lens 20a. The lens 20a is, for example, a single focal lens or a zoom lens. The lens 20a is generally a compound lens made up of a combination of a plurality of lenses, but may be a single lens. The optical system unit 20 may be of an autofocus system or a fixed focus system.

The imaging element 30 is an electronic component that performs photoelectric conversion. In other words, the imaging element 30 is a device that forms an image on the light receiving surface 30a of the imaging element 30 by irradiating the light L, which is emitted or reflected light from the subject 4 located a distance D (depth) away from the lens 20a, through the optical system unit 20 and photoelectrically converts the brightness and darkness of the image into an amount of electric charge, which is then read out and converted into an electrical signal.

The imaging element 30 generally includes a plurality of photoelectric conversion elements arranged in a two-dimensional array, and the plurality of photoelectric conversion elements forms the light receiving surface 30a. The imaging element 30 is disposed at a position where the light L that has entered the optical system unit 20 from the subject 4 and passed through the optical system unit 20 is received by the light receiving surface 30a. The imaging element 30 converts the intensity of light, that is, brightness, received by the light receiving surface 30a, into an electrical signal and outputs an image signal. The imaging element 30 may be one that outputs a color image signal representing a color image, or one that outputs a monochrome image signal representing a monochrome image.

The imaging element 30 is, for example, a Charge Coupled Device (CCD) image sensor or a Complementary Metal Oxide Semiconductor (COMS) image sensor.

The liquid crystal mask unit 40 is provided in front of the optical system unit 20 on the subject 4 side. The liquid crystal mask unit 40 has a function of making any one of a plurality of predetermined masks appear, or making none of the masks appear. The liquid crystal mask unit 40 may be provided inside the optical system unit 20.

In the second embodiment, the liquid crystal mask unit 40 is configured to switch between a state where either the mask M1 or the M2 is installed or a state where no mask is installed, on the subject 4 side of the optical system unit 20. The liquid crystal mask unit 40 includes the liquid crystal optical shutter 1 described above.

The optical system control unit 21 adjusts positions of the movable parts included in the optical system unit 20 based on a control signal received from the arithmetic control unit 10. The optical system control unit 21 includes, for example, a drive motor, and moves at least a part of the lens by operating the drive motor.

If the optical system unit 20 includes a zoom lens, the optical system control unit 21 may change the zoom magnification by moving a part of a lens group that makes up the zoom lens or adjust the focus by moving the entire zoom lens. When the optical system unit 20 includes a single focal lens, the focus may be adjusted by moving the entire lens. If the optical system unit 20 includes an aperture mechanism, the aperture diameter may be adjusted by operating the aperture mechanism.

The imaging element control unit 31 executes imaging by reading the image signal output from the imaging element 30 based on a control signal received from the arithmetic control unit 10. The imaging element control unit 31 transmits the read image signal to the arithmetic control unit 10. The shutter method used when controlling the imaging element 30 to image the subject 4 may be, for example, a global shutter method or a rolling shutter method.

The liquid crystal mask control unit 41 controls the liquid crystal mask unit 40 based on a control signal received from the arithmetic control unit 10, and implements a state in which the intended mask M is installed in the liquid crystal mask unit 40, or a state in which the mask M is not installed.

### Configuration Example of Arithmetic Control Unit

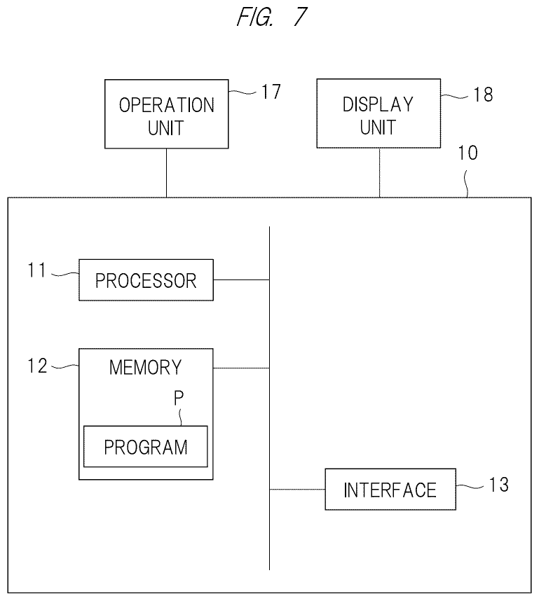

FIG. 7 is a diagram illustrating an example of a configuration of the arithmetic control unit 10 according to the second embodiment. As illustrated in FIG. 7, the arithmetic control unit 10 is, for example, a computer, and includes a processor 11, a memory 12, and an interface 13.

The memory 12 stores a program P that is used by the processor 11 to execute various types of arithmetic processing or image processing, and to execute various types of control processing. Also, the memory 12 stores data to be processed by the processor 11 temporarily or long-term.

The processor 11 reads out and executes the program P stored in the memory 12, thereby executing various types of processing including arithmetic processing, image processing, and control processing. When executing various types of processing, the processor 11 stores data in the memory 12 and accesses the data stored in the memory 12 to execute the processing.

In addition, part of various processing, the processor 11 executes maskless imaging processing, representative edge direction determination processing, mask selection processing, first mask imaging processing, second mask imaging processing, decoding processing, estimation processing of depth of subject, depth map generation processing, data output processing, and imaging continuation determination processing. The various processing will be described in detail later.

The processor 11 transmits control signals to the optical system control unit 21, the imaging element control unit 31, and the liquid crystal mask control unit 41 to execute the above-mentioned maskless imaging processing, representative edge direction determination processing, mask selection processing, first mask imaging processing, and second mask imaging processing.

The interface 13 is connected to an external device 3 and transmits a decoded image or a depth map DM generated in the arithmetic control unit 10 to the external device 3.

In addition, all or part of the above computer may be composed of semiconductor circuits such as a Digital Signal Processor (DSP), an Application Specific Integrated Circuit (ASIC), a Field Programmable Gate Array (FPGA), or a Complex Programmable Logic Device (CPLD).

The external device 3 is, for example, an image processing device, a vehicle operation assistance device, or the like. The image processing device applies processing to an imaged image, for example, by blurring the background that is farther from the optical system and to emphasize the subject of interest. The vehicle operation assistance device, for example, detects the position of objects around the vehicle or their relative speed and issues warnings or controls the vehicle to avoid danger.

An operation unit 17 and a display unit 18 are connected to the arithmetic control unit 10. The operation unit 17 is for accepting input operations from the user, and the display unit 18 is for visually outputting information to the user. The operation unit 17 is, for example, a keyboard, a mouse, a button, a dial, and the like. The display unit 18 is, for example, a liquid crystal panel, an organic EL panel, or the like. The operation unit 17 and the display unit 18 may be an integrated touch panel. The operation unit 17 and the display unit 18 may be provided on the external device 3.

### Operation Flow of Imaging Device

The imaging device according to the second embodiment will be described.

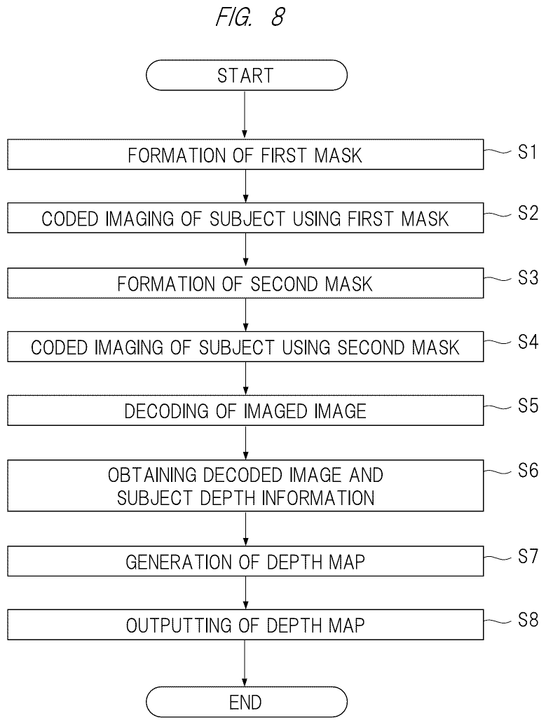

FIG. 8 is a flowchart illustrating an example of an operation flow of the imaging device 2 according to the second embodiment.

As illustrated in FIG. 8, in Step S1, a first mask M1 is formed. Specifically, the arithmetic control unit 10 transmits a control signal to the liquid crystal mask control unit 41 so that the mask M1 is formed on the liquid crystal optical shutter 1. Based on the received control signal, the liquid crystal mask control unit 41 applies the necessary electrical signals to each electrode of the liquid crystal optical shutter 1, and controls the state of each segment to the light-transmitting state or the light-shielding state, thereby creating a state in which the mask M1 is formed.

In Step S2, coded imaging of the subject is performed using the first mask. Specifically, the arithmetic control unit 10 transmits a control signal to the imaging element control unit 31 so that the subject 4 is subjected to coded imaging using the formed mask M1. Based on the received control signal, the imaging element control unit 31 controls the imaging element 30 so that the subject 4 is imaged, that is, so that an imaged image P1 of the subject 4 represented by an output signal of the imaging element 30 is transmitted to the arithmetic control unit 10.

In Step S3, a second mask M2 is formed. Specifically, the arithmetic control unit 10 transmits a control signal to the liquid crystal mask control unit 41 so that the mask M2 is formed on the liquid crystal optical shutter 1. Based on the received control signal, the liquid crystal mask control unit 41 applies the necessary electrical signals to each electrode of the liquid crystal optical shutter 1, and controls the state of each segment to the light-transmitting state or the light-shielding state, thereby creating a state in which the mask M2 is formed.

In Step S4, coded imaging of the subject is performed using the second mask. Specifically, the arithmetic control unit 10 transmits a control signal to the imaging element control unit 31 so that the subject 4 is subjected to coded imaging using the formed mask M2. Based on the received control signal, the imaging element control unit 31 controls the imaging element 30 so that the subject 4 is imaged, that is, so that an imaged image P2 of the subject 4 represented by an output signal of the imaging element 30 is transmitted to the arithmetic control unit 10.

In Step S5, the imaged image is decoded. Specifically, the arithmetic control unit 10 performs decoding on the obtained imaged images P1 and P2 based on the point spread function corresponding to the mask M1 and the point spread function corresponding to the mask M2.

In Step S6, a decoded image and subject depth information are obtained. Specifically, the arithmetic control unit 10 obtains a decoded image of the subject 4 and depth estimation information of an object corresponding to each position in the decoded image, based on the information obtained by the above-mentioned decoding.

In Step S7, a depth map is generated. Specifically, the arithmetic control unit 10 generates a depth map DM of the subject 4 based on the obtained decoded image and the depth estimation information.

In Step S8, the depth map is output. Specifically, the arithmetic control unit 10 outputs the generated depth map DM to the external device 3.

According to the second embodiment, a more practical DFD technique can be provided. More specifically, in the imaging device 2, the liquid crystal optical shutter 1 implements the formation of masks used in coded imaging. The liquid crystal optical shutter 1 can implement any masks depending on the design of the segments, and it is not required to physically switch hardware to switch the state of mask. Therefore, the position of the mask can be controlled more accurately, and the mechanism for switching between the masks can be simplified.

Although various embodiments of the present disclosure have been described above, the present disclosure is not limited to the above-described embodiments and includes various modifications. Further, the above-described embodiments have been described in detail to clearly explain the present disclosure, and the present disclosure is not necessarily limited to having all of the configurations described. Furthermore, it is possible to replace part of the configuration of one embodiment with that of another embodiment, or to add the configuration of one embodiment to that of another. All of these fall within the scope of the present disclosure. Furthermore, the numerical values and the like included in the text and figures are merely examples, and using different numerical values and the like does not compromise the effects of the present disclosure.

What is claimed is:

1. A liquid crystal optical shutter configured to form a mask used in coded imaging comprising:
a first transparent electrode layer;
a second transparent electrode layer disposed opposite the first transparent electrode layer and having a plurality of transparent segment electrodes;
a liquid crystal layer disposed between the first transparent electrode layer and the second transparent electrode layer; and
a light-shielding layer in which an aperture corresponding to a region including a light entry region of an optical system used for the coded imaging and wider than the light entry region, and configured to shield light in a region outside the aperture,
wherein the plurality of segment electrodes includes a peripheral segment electrode corresponding to a peripheral region of the light entry region including an outline of the aperture, and
wherein the mask is formed by controlling electrical signals applied to the first transparent electrode layer and each of the plurality of segment electrodes.

2. The liquid crystal optical shutter according to claim 1,
wherein the light entry region is a circular region, and
wherein the peripheral segment electrode has a ring shape.

3. The liquid crystal optical shutter according to claim 1,
wherein a plurality of the masks being different from each other is formed by controlling electrical signals applied to the first transparent electrode layer and each of the plurality of segment electrodes.

4. The liquid crystal optical shutter according to claim 1,
wherein a segment corresponding to the peripheral segment electrode is in a light-shielding state when the mask is formed.

5. The liquid crystal optical shutter according to claim 2,
wherein a width of the peripheral segment electrodes is 10 μm or more and 30 μm or less.

6. The liquid crystal optical shutter according to claim 3,
wherein, of the plurality of segment electrodes, two or more segment electrodes corresponding to segments that are commonly in a light-shielding state when the plurality of masks is formed include the peripheral segment electrode and are connected to each other.

7. An imaging device including a liquid crystal optical shutter configured to form a mask used in coded imaging,
wherein the liquid crystal optical shutter includes
a first transparent electrode layer,
a second transparent electrode layer disposed opposite the first transparent electrode layer and having a plurality of transparent segment electrodes,
a liquid crystal layer disposed between the first transparent electrode layer and the second transparent electrode layer, and
a light-shielding layer in which an aperture corresponding to a region including a light entry region of an optical system used for the coded imaging and wider than the light entry region, and configured to shield light in a region outside the aperture,
wherein the plurality of segment electrodes includes a peripheral segment electrode corresponding to a peripheral region of the light entry region including an outline of the aperture, and
wherein the mask is formed by controlling electrical signals applied to the first transparent electrode layer and each of the plurality of segment electrodes.

8. The imaging device according to claim 7,
wherein the light entry region is a circular region, and
wherein the peripheral segment electrode has a ring shape.

9. The imaging device according to claim 7,
wherein a plurality of the masks being different from each other is formed by controlling electrical signals applied to the first transparent electrode layer and each of the plurality of segment electrodes.

10. The imaging device according to claim 7,
wherein a segment corresponding to the peripheral segment electrode is in a light-shielding state when the mask is formed.

11. The imaging device according to claim 8,
wherein a width of the peripheral segment electrodes is 10 μm or more and 30 μm or less.

12. The imaging device according to claim 9,
wherein, of the plurality of segment electrodes, two or more segment electrodes corresponding to segments that are commonly in a light-shielding state when the plurality of masks is formed include the peripheral segment electrode and are connected to each other.
